(19) United States
(12) Patent Application Publication
(10) Pub. No.: US 2021/0347011 A1
(43) Pub. Date: Nov. 11, 2021

(54) MANUFACTURING METHOD OF MATERIAL

(71) Applicants: NIPPON STEEL CORPORATION, Tokyo (JP); JAPAN BLAST PROCESS RESEARCHES CO.,LTD, Tokyo (JP)

(72) Inventors: Michio KANEKO, Tokyo (JP); Kiyonori TOKUNO, Tokyo (JP); Satoshi SHIMAZAKI, Tokyo (JP)

(73) Assignees: NIPPON STEEL CORPORATION, Tokyo (JP); JAPAN BLAST PROCESS RESEARCHES CO.,LTD, Tokyo (JP)

(21) Appl. No.: 17/278,574

(22) PCT Filed: Oct. 28, 2019
(86) PCT No.: PCT/JP2019/042181

§ 371 Date: Mar. 22, 2021

(30) Foreign Application Priority Data
Oct. 30, 2018 (JP) 2018-203984

(51) Int. Cl. B24C 1/08; C22F 1/18

(52) U.S. Cl. CPC B24C 1/08; C22F 1/183

(57) ABSTRACT

A manufacturing method of a material, including: a first process of placing a blast transfer material on a surface of a base material, and a second process of blasting to the surface of the base material through the blast transfer material, wherein the blast transfer material is nonuniform in one or more of density, thickness, and hardness.

### TECHNICAL FIELD

The present invention relates to a manufacturing method of a material. In detail, the present invention relates to a material having a pattern, such as unevenness, and more detail, to a design material having a texture of natural origin, such as a woodgrain tone.

This application is based upon and claims the benefit of priority of the prior Japanese Patent Application No. 2018-203984, filed in Japan on Oct. 30, 2018, the entire contents of which are incorporated herein by reference.

### BACKGROUND ART

Finishing materials used for interior and exterior of buildings and interior materials of transport equipment such as automobiles require a high degree of design depending on cases. Materials with a woodgrain tone or texture of natural materials are used relatively frequently in the above applications, as they have an excellent appearance in themselves and can easily blend in with their surroundings.

Several attempts are known to reproduce such a woodgrain texture in metal materials. For example, Patent Document 1 proposes a manufacturing method of a metal material in which a surface of the metal material is cut to form a woodgrain streak pattern, and the surface is then painted. In Patent Document 2, a stainless-steel decorative panel with a woodgrain pattern is proposed, wherein protruding portions are mirror-finished and recessed portions are matte-finished, which is obtained by rolling and transferring a work roll where a stainless-steel strip is patterned.

As a manufacturing method of a member having surface unevenness formed of stainless steel, Patent Document 3 discloses a method of attaching a masking material to a starting member and blasting it.

### PRIOR ART DOCUMENT

### Patent Document

[Patent Document 1] Japanese Laid-open Patent Publication No. 2004-338153

[Patent Document 2] Japanese Utility Model Application Publication No. S55-67900

[Patent Document 3] Japanese Laid-open Patent Publication No. 2018-28142

### DISCLOSURE OF THE INVENTION

### Problems to Be Solved by the Invention

However, in the grain of the wood and patterns existing in natural materials, there are many blurred regions without clear boundaries as well as clear contours. While the methods described in Patent Documents 1 to 3 can form clear contours and unevenness, such blurred regions cannot be formed. Further, until now, there is no known method of expressing such blurred regions on a surface of a base material such as a metal plate.

The present invention has been made because of the above problems, and an object of the present invention is to provide a manufacturing method of a material capable of forming natural blurred regions without clear boundaries and capable of expressing a pattern derived from a raw material.

### Means for Solving the Problems

To solve the above-mentioned problems, the inventors made keen investigations and found that by placing a masking material, such as a wood veneer or a fiber sheet, on a base material used as the material, and blasting from above the masking material, a pattern sufficiently reflecting the pattern possessed by the masking material can be formed on the base material, and as a result of further investigation, the present invention was made.

The masking material referred to herein is not to protect the base material, but is used to transfer a pattern derived from the masking material to the base material by blasting, and is referred to herein as a “blast transfer material” in this specification.

The gist of the present invention completed based on the above findings is as follows.
(1)

A manufacturing method of a material, including:

a first process of placing a blast transfer material on a surface of a base material, and

a second process of blasting to the surface of the base material through the blast transfer material, wherein

the blast transfer material is nonuniform in one or more of density, thickness, and hardness.
(2)

The manufacturing method of the material according to (1), further including:

a process of removing the blast transfer material after the second process.
(3)

The manufacturing method of the material according to (1) or (2), wherein

the blast transfer material is one or both of a wood veneer and a fiber sheet.
(4)

The manufacturing method of the material according to (3), wherein

the fiber sheet is a cloth or a Japanese paper.
(5)

The manufacturing method of the material according to (1) to (4), wherein

the base material is a glass material, a ceramic material, a resin material, concrete, stone, graphite, cloth, a paper material, wood, a woody material, a leather material, or a metal material.
(6)

The manufacturing method of the material according to (5), wherein

the base material is the metal material of any of a titanium material, a stainless-steel material, and an aluminum material.
(7)

The manufacturing method of the material according to (6), wherein

in the blasting process, blasting media with an average particle size of 50 μm or more and 1000 μm or less is used.
(8)

The manufacturing method of the material according to (6) or (7), wherein

a blasting pressure in the blasting process is 0.20 MPa or more and 0.80 MPa or less.
(9)

The manufacturing method of the material according to any one of (6) to (8), wherein

a thickness of the blast transfer material is 0.10 mm or more and 1.00 mm or less.
(10)

The manufacturing method of the material according to (6) to (9), wherein

the base material is the titanium material, and

a process of vacuum annealing or pickling the titanium material before the first process is included.
(11)

The manufacturing method of the material according to any one of (1) to (10), wherein

the material is a material for consumer electronics casing, a material for information equipment casing, a material for residential equipment, a material for clocks, a material for ornaments, a material for signboards, a material for nameplates, a material for sign markers, a material for stationery, a material for containers, a material for residential furniture, a material for custom-made furniture, a finishing material for construction, or a material for transport equipment.

### Effect of the Invention

As explained above, the present invention makes it possible to provide a manufacturing method of a material capable of forming natural blurred regions without clear boundaries and capable of expressing a pattern derived from a raw material.

### BRIEF DESCRIPTION OF THE DRAWINGS

FIG. 1 is a schematic diagram to explain a flow of a manufacturing method of a material according to one embodiment of the present invention.

FIG. 2 is a schematic diagram to explain a process of formation of a pattern.

FIG. 3(a) and FIG. 3(b) are each a schematic diagram to explain a process of formation of a blurred region without a boundary.

FIG. 4 is a schematic explanatory diagram illustrating the blurred regions without boundaries.

FIG. 5 is a photograph of a material in Example 1.

### EMBODIMENTS FOR CARRYING OUT THE INVENTION

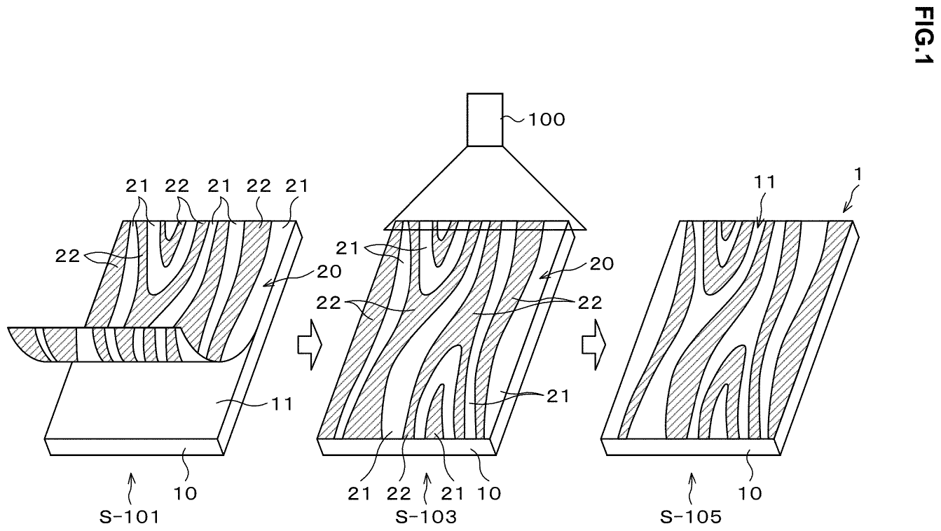

Hereinafter, preferred embodiments of the present invention are explained in detail with reference to the drawings. FIG. 1 is a schematic diagram to explain a flow of a manufacturing method of a material in this embodiment. The manufacturing method of the material in this embodiment includes: a first process of placing a blast transfer material 20 on a surface of a base material 10, and a second process of blasting to the surface of the base material 10 through the blast transfer material 20. The blast transfer material 20 is in a sheet form capable of covering the surface of the base material 10, and the blast transfer material 20 is nonuniform in one or more of density, thickness, and hardness in an entire area thereof. For example, at least one region of the blast transfer material 20 has a relatively high density and at least another region has a relatively low density. For example, at least one region of the blast transfer material 20 is relatively thick and at least another region is relatively thin in thickness. Alternatively, for example, at least one region of the blast transfer material 20 is relatively high in hardness and at least another region is relatively low in hardness. Such a blast transfer material 20 is, for example, a wood veneer and/or a fiber sheet. In this embodiment, the manufacturing method of the material further includes a base material preparation process of preparing the base material 10, which is performed before the first process, and a post-processing process, which is performed after the second process. Each of the processes will be described in detail below.

1. Base Material Preparation Process

In this process, the base material 10 is first prepared.

The base material 10 is not particularly limited and includes: for example, concrete; stone such as marble and granite; graphite; cloth; a paper material; wood; a woody material; a leather material; a plated steel material; a metal material such as a copper material, a titanium material, a stainless steel material, and an aluminum material; a glass material; a ceramic material; a resin material, and the like.

Among the aforementioned, the base material 10 is preferably the glass material, the resin material, the stone, or the metal material in terms of corrosion resistance and durability. The base material 10 is more preferably the aluminum material, the stainless-steel material, or the titanium material in terms of corrosion resistance and formability. In particular, the titanium material is suitably used as the base material since it has excellent corrosion resistance in harsh corrosive environments.

Pure titanium or titanium alloys can be used as the titanium material used for the base material 10. Pure titanium and titanium alloys are collectively referred to as “titanium”. For example, industrial titanium may be used as such a titanium material. The industrial titanium that can be used for the base material 10 includes, for example, various types of industrial titanium described in JIS H 4600:2012 and JIS H 4650:2012. JIS Class 1 (e.g., JIS H 4600) commercially pure titanium with reduced impurities is suitable when workability is required. JIS Classes 2 to 4 commercially pure titanium can also be applied when strength is required. Titanium alloys include, for example, JIS Classes 11 to 23, to which trace amounts of noble-metal-base elements (palladium, platinum, ruthenium, and the like) are added to improve the corrosion resistance, and JIS Class 60 (for example, Ti-6Al-4V-based alloy), classes 60E, 61, 61F, 80, and the like, which contains a relatively large amount of additive elements.

However, when a large amount of aluminum is contained, such as in the Ti-6Al-4V-based alloy, the corrosion resistance may be degraded and discoloration resistance may be adversely affected. Therefore, when forming a titanium oxide layer on a surface of the titanium alloy as the base material 10, it is recommended that the influence of the alloying elements on the application is investigated beforehand, and a composition and a thickness of each layer should be adjusted appropriately according to the base material 10.

Alternatively, the base material 10 can be commercially pure titanium containing, for example, in mass %,
N: 0% or more and 0.050% or less,
C: 0% or more and 0.10% or less,
H: 0% or more and 0.015% or less,
O: 0% or more and 0.35% or less, and
Fe: 0% or more and 0.50% or less,
   with the balance containing Ti and impurities.

Furthermore, the base material 10 can be a commercially titanium alloy containing, for example, in mass %, one or two or more types selected from the group consisting of:
Al: 5.0% or more and 7.0% or less,
V: 3.0% or more and 5.0% or less,
Co: 0.10% or more and 1.0% or less,
Ni: 0.10% or more and 1.0% or less,
Pd: 0.010% or more and 0.30% or less, and
Ru: 0.010% or more and 0.30% or less, and containing:
N: 0% or more and 0.050% or less,
C: 0% or more and 0.10% or less,
H: 0% or more and 0.015% or less,
O: 0% or more and 0.35% or less, and
Fe: 0% or more and 0.50% or less,
   with the balance containing Ti and impurities.

The impurities are components that are present in titanium, regardless of the intention of addition, and are not inherently necessary to be present in a resulting material. The term “impurities” is a concept that includes impurities that are introduced into titanium from raw materials or manufacturing environments when titanium is produced industrially. Such impurities may be contained in amounts that do not adversely affect the effect of the invention of the present application.

As impurities, residuals of the blasting media resulting from a blasting process described below may be contained in a material 1 produced using the base material 10. Such impurities resulting from the blasting process may be present near a surface of the material 1. For example, when the blasting media is alumina particles, less than 20 atom % of Al, or when the blasting media is SiC particles, less than 20 atom % of Si or C, can be present near the surface of the material 1 as impurities.

The stainless-steel material is not particularly limited, and, for example, various austenitic, austenite-ferritic, ferritic, martensitic, and precipitation-hardened stainless steels described in JIS G 4305:2012 can be used. Concretely, SUS 304, SUS 316, SUS 329J1, SUS 430, SUS 410, SUS 630, and the like can be used as the base material 10.

The aluminum material is not particularly limited and, for example, commercially pure aluminum and aluminum alloys can be used. Concretely, commercially pure aluminum includes A1085P, A1080P, A1070P, A1050P, A1100P, A1200P, A1N00P, A1N30P, and others described in JIS H 4000:2006. Aluminum alloys include A2014P, A2014PC, A2017P, A2219P, A2024P, A2024PC, A3003P, A3103P, A3203P, A3004P, A3104P, A3005P, A3105P, A5005P, A5052P, A5652P, A5154P, A5254P, A5454P, A5082P, A5083P, A5083PS, A5086P, A5N01P, A6061P, A7075P, A7075PC, A7N01P, A8021P, A8079P, and others described in JIS H4000:2006.

For example, various types of plated steel materials with aluminum plating, zinc-based plating, and alloyed zinc plating can be used as the plated steel materials. Zinc-based plating and alloyed zinc plating include, for example, molten Zn plating, alloyed molten Zn plating, molten Zn-55% Al-1.6% Si plating, molten Zn-11% Al plating, molten Zn-11% Al-3% Mg Plating, molten Zn-6% Al-3% Mg Plating, molten Zn-11% Al-3% Mg-0.2% Si plating, electric Zn plating, electric Zn—Ni plating, and electric Zn—Co plating. The aluminum plating includes, for example, molten aluminum plating, molten aluminum-silicon alloy, and the like.

The copper material is not also particularly limited, and, for example, industrial copper and copper alloys described in JIS H 3100:2012 can be used. Concretely, the copper materials include various sheets, strips, and the like represented by alloy numbers of C1020, C1100, C1201, C1220, C1441, C1510, C1921, C1940, C2051, C2100, C2200, C2300, C2400, C2600, C2680, C2720, C2801, C3710, C3713, C4250, C4450, C4621, C4640, C6140, C6161, C6280, C7060, C7150, and C7250 described in JIS H 3100:2012.

For example, soda-lime glass, borosilicate glass, quartz glass, crystal glass, and the like can be used as the glass material.

For example, acrylic, polyethylene, polyvinyl chloride, polyurethane, polycarbonate, polytetrafluoroethylene, and the like can be used as the resin material.

For example, plywood, laminated wood, particleboard, fiberboard, and the like can be used as the woody material.

The wood is not particularly limited, and for example, any species of wood that can be used as a furniture material or an architecture material can be used. Concretely, cedar, pine, oak, elm, zelkova, Japanese oak, paulownia, Japanese cypress, mahogany, walnut, teak, rosewood, ebony, and the like can be used as the wood.

As the graphite, both natural graphite and artificial graphite can be used, as well as lumps of these, which are bonded with resins or other materials.

The paper material includes, for example, Western paper such as paperboard, coated paper, special paper, and miscellaneous paper, and various types of traditional Japanese paper (washi.) Paper raw materials forming the paper material are not particularly limited and can include, for example, a variety of known raw materials of paper, such as wood.

For example, ceramics, gypsum, cement, alumina, zirconia, and the like. can be used as the ceramic material.

For example, woven fabric and nonwoven fabric made of natural fibers such as cotton, linen, silk, and wool, or synthetic fibers such as nylon, vinylon, and polyester, or a mixture of natural and synthetic fibers, rubberized fabric, and the like can be used as the cloth.

Man-made leather such as artificial leather and synthetic leather, and natural leather can be used as the leather material.

A shape of the base material 10 is not particularly limited and is usually a sheet, coil, strip, tube, and bar and wire, or a shape in which these shapes are processed as appropriate. However, the base material 10 may be of any shape, for example, a spherical or rectangular shape. In this embodiment, it will be explained that the base material 10 is the sheet as a representative of these shapes.

The base material 10 described above may be pre-processed as necessary. The preprocessing may include, for example, various surface treatments such as cleaning, coating, and an anodic oxidation treatment of the surface of the base material 10, and annealing, and others.

When the base material 10 is the titanium material, it is preferable to have a process of vacuum annealing or pickling the titanium material before the first process. This can reduce the amount of titanium carbide (TiC) present near the surface of the base material 10 and improve the discoloration resistance of the resulting material 1.

When the titanium material as the base material 10 is in a form of a thin sheet, the titanium material is rolled to a predetermined thickness by cold-rolling and then annealed. When the titanium material is annealed in air, an oxide scale can be removed by pickling. On the other hand, when the titanium material is annealed in a vacuum, the process such as removal of scale, which is formed during annealing, can be omitted. The titanium material may be processed without annealing (as cold-rolled) though processability of the base material is restricted (a processable range is reduced) compared with the vacuum annealing, which will be described below, or the titanium material may be heat-treated at a temperature at which it is β-structured by phase transformation, for example, at 900° C. or higher for one minute or more. These processes can be performed under conditions that are selectable to those skilled in the art, as appropriate.

In the case of the vacuum annealing, an annealing temperature can be adjusted appropriately according to required mechanical properties of the base material 10, but 650° C. or more is preferable. An upper limit of the annealing temperature should be less than 820° C. to prevent β-structure formation due to the phase transformation. A process time is preferably 12 hours or more. In the case of multiple vacuum annealing, the total holding time at 650° C. or higher is preferably 12 hours or more. Although there is no restriction on an upper limit of the holding time, 24 hours or less is preferred for productivity reasons. It is preferable to remove oil content by alkaline degreasing before applying the vacuum annealing.

In the case of the pickling, for example, a mixed aqueous solution of nitric acid and hydrofluoric acid can be used, a treatment temperature (aqueous solution temperature) is 5° C. or more and 80° C. or less, and a treatment time is 10 seconds or more and 30 seconds or less. A concentration of nitric acid in the above mixed aqueous solution is, for example, 10 g/L or more, and a concentration of hydrofluoric acid is, for example, 0.5 g/L or more. The concentration of nitric acid is preferably 80 g/L or less, and more preferably 50 g/L or less. This prevents fluoride from remaining on the surface of the base material 10 after pickling.

A dull-rolled finish may be performed as the preprocessing other than the annealing and the pickling or may be performed after the pickling. For example, the preprocessing can be varied to suit architect's requirements.

2. First Process

Next, in the first process, the blast transfer material 20 is placed on a surface 11 of the base material 10 (S-101). Here, the blast transfer material 20 is in a sheet form capable of covering the surface of the base material 10 and is nonuniform in one or more of density, thickness, and hardness in an entire area thereof. In this embodiment, the blast transfer material 20 is, for example, one or both of a wood veneer and a fiber sheet.

The wood veneer and the fiber sheet have nonuniform physical properties such as density, thickness, and hardness, in a surface direction due to their structure. The inventors have found that by using such a nonuniform wood veneer or fiber sheet as the blast transfer material 20 and blasting through the blast transfer material 20, a pattern derived from the nonuniform wood veneer or fiber sheet is formed on the base material 10. It is believed that grinding of the blast transfer material 20 proceeds in a nonuniform manner during the blasting process due to the nonuniformity of the blast transfer material 20, and the blasting process to which the base material 10 is subjected to becomes nonuniform.

The wood veneer is a plate material in a sheet form obtained by slicing wood into thin slices. The wood veneer has a grain originating from the wood as a raw material. The woodgrain is formed of an early wood portion, which is relatively low in density and hardness, and a late wood portion, which is relatively high in density and hardness, which makes the wood veneer nonuniform in density and hardness corresponding to the woodgrain pattern. Therefore, by using the wood veneer as the blast transfer material 20, the woodgrain pattern can be formed on the surface 11 of the base material 10 in the second process.

The type of wood used as the raw material for the wood veneer is not particularly limited and includes cedar, pine, oak, elm, zelkova, Japanese oak, paulownia, Japanese cypress, mahogany, walnut, teak, rosewood, ebony, and the like, and is selected as appropriate according to the woodgrain pattern desired in the material 1.

The fiber sheet is formed by arranging fibers regularly or irregularly. The fiber sheet is nonuniform in density, thickness, and hardness in the surface direction, depending on a fiber material and a method of arranging the fibers. Therefore, when the fiber sheet is used as the blast transfer material 20, the pattern resulting from the arrangement of the fibers of the fiber sheet is formed on the surface 11 of the base material 10, in the second process described below.

The fiber sheets include: cloth such as woven fabric, nonwoven fabric, and lace-stitched or embroidered woven and nonwoven fabrics; and paper such as traditional Japanese paper (washi) and Western paper. Among the aforementioned, traditional Japanese paper (washi) has an excellent design quality and can be suitably used as the blast transfer material 20 because it has a unique texture and pattern. The cloth is also advantageous in processing a large area of the base material 10 because it can be made and obtained in a large area.

Raw materials for the fiber sheet are not particularly limited and include chemical fibers, fiber yarns such as cotton, silk, and linen, and various fiber materials such as paper mulberry, mitsumata plant, bamboo, straw, flax, sugarcane, Manila hemp, kenaf, banana, oil palm, papyrus, and wood pulp (mechanical pulp and chemical pulp). As the raw material for the fiber sheet, one of the above materials may be used alone or in a combination of two or more of them, depending on the pattern and texture required for the material 1.

The thickness of the blast transfer material 20 is not particularly limited, but is, for example, 0.10 mm or more and 1.00 mm or less, preferably 0.20 mm or more and 0.60 mm or less. This makes it possible to more reliably form a pattern with excellent design corresponding to the pattern of the blast transfer material 20 without excessively grinding the surface of the base material 10 in the second process. In this embodiment, the thickness of the blast transfer material 20 means an average thickness of the blast transfer material 20 and is measured by an arithmetic average of ten points measured by a caliper or a micrometer.

A placement of the blast transfer material 20 on the surface 11 of the base material 10 is usually performed by attaching the blast transfer material 20 to the surface of the base material 10. Known adhesives may be used in attaching the blast transfer material 20 to the base material 10. A water-soluble adhesive, concretely a water-soluble glue, is preferably used as such an adhesive, taking into consideration the removal of the remaining blast transfer material 20 in a subsequent process.

A plurality of wood veneers and fiber sheets may be used at the same time as the blast transfer material 20 for one base material 10. This makes it possible to form a plurality of patterns on the material 1 or to manufacture a plurality of parts and products from the material 1.

3. Second Process

Next, in the second process, the blasting process is performed on the surface 11 of the base material 10 through the blast transfer material 20 (S-103). The blasting process is performed by projecting blasting media onto the surface of the base material 10 on which the blast transfer material 20 is placed.

By blasting the surface 11 of the base material 10 through the blast transfer material 20, a material-derived pattern is formed along with natural blurred regions without clear boundaries. That is, at the start of the blasting process, the blasting media first collides with the blast transfer material 20 and grinds the blast transfer material 20. At this time, since the blast transfer material 20 is nonuniform in one or more of its thickness, hardness, and density, a degree of progress of grinding and disappearance in each part of the blast transfer material 20 is also nonuniform following these thicknesses, hardness, and density. Subsequently, as the blasting process proceeds, the surface 11 of the base material 10 is preferentially exposed in portions where the grinding of the blast transfer material 20 is likely to proceed, and the blasting media collides with the surface 11 of the base material 10. Thus, depending on the nonuniformity of the blast transfer material 20, a frequency of collision of the blasting media of the blasting process differs from one part of the base material 10 to another, and the degree of the blasting process differs from one part of the base material 10 to another. As a result, a pattern derived from the blast transfer material 20 is formed on the surface 11 of the base material 10 with natural blurred regions without clear boundaries.

The blasting method includes mechanical (impeller projection), pneumatic (air nozzle type), and wet methods, and may be any of these methods. Among the above, the pneumatic method is advantageous because the pneumatic method is capable of projecting the blasting media evenly over the entire target portion, and conditions can be adjusted easily. In an illustrated mode, the pneumatic method is employed, and a jet of the blasting media is performed from an air nozzle 100 to blast the base material 10.

The blasting media used in the blasting process is not particularly limited, and for example, ceramic-based blasting media such as zirconia particles, glass particles, alumina particles, and SiC particles can be used. Among the above-mentioned, alumina particles and zirconia particles can further improve the design of the pattern formed on the surface 11 of the base material 10. Since the texture of the resulting material 1 changes depending on the type of the base material 10, and a combination of the type of the used blasting media and the type of the blast transfer material 20, the blasting media may be selected in consideration of these factors.

An average particle size of the blasting media is not particularly limited, but when the base material is the metal material of any of the titanium material, the stainless steel material, or the aluminum material, for example, the average particle size is preferably 50 μm or more and 1,000 μm or less in terms of adequately grinding the collied portion of the blast transfer material 20 with the blasting media and forming the pattern on the surface of the base material 10. A lower limit of the average particle size of the blasting media is preferably 70 pm, and more preferably 10 μm. An upper limit of the average particle size of the blasting media is preferably 800 μm, and more preferably 500 μm. Here, the average particle size of the blasting media can be measured based on JIS 8827-01:2008, for example.

A shape of each of the blasting media is not particularly limited and can be selected as appropriate depending on the texture of the material 1 to be manufactured, and for example, a grid, a shot, a bead, a cut wire, or the like may be used as the blasting media. The grid is a nonspherical particle (polygonal particle) with sharp angles. The shot is usually a spherical, non-angular particle, such as a bead. The bead is a spherical particle. The cut-wire-form means a cylindrical particle cut from a wire. The grid is used to form sharp unevenness on the surface 11 of the base material 10. The grid is the blasting media suitable for breaking a weak portion of the wood veneer and forming the unevenness on a metallic titanium surface at the broken portion when the base material is, for example, the metal material such as the titanium material, the stainless-steel material, or the aluminum material.

Although a blasting pressure of the blasting media at the time of blasting is not particularly limited, it is preferably 0.20 MPa or more and 0.80 MPa or less when the base material is, for example, the metal material of any of the titanium material, the stainless-steel material, and the aluminum material. A lower limit of the blasting pressure of the blasting media is preferably 0.30 MPa, and more preferably 0.40 MPa. An upper limit of the blasting pressure of the blasting media is preferably 0.70 MPa, and more preferably 0.6 MPa. This enables the blasting media to be projected onto the surface of the base material 10 and the blast transfer material 20 with a moderate projection strength, which enables a pattern derived from the blast transfer material 20 to be formed over the entire blasted portion and prevents defects such as flaws caused by the blasting media.

A projection angle is not particularly limited and can be 45 to 90 degrees (perpendicular) to the surface of the base material 10 to be projected.

The blasting process may be performed until all of the blast transfer material 20 has been removed, but the blasting process may be completed following a formation state of the pattern on the surface of the base material 10 even in a situation where the blast transfer material 20 has partially disappeared.

Here, the case of using the wood veneer as the blast transfer material 20 will be described in more detail. As illustrated in FIG. 1, the blast transfer material 20 made of the wood veneer is formed by an early wood portion 21, which is relatively low in density and hardness, and a late wood portion 22, which is relatively high in density and hardness, whereby the wood veneer is nonuniform in density and hardness corresponding to the woodgrain pattern in the entire area thereof.

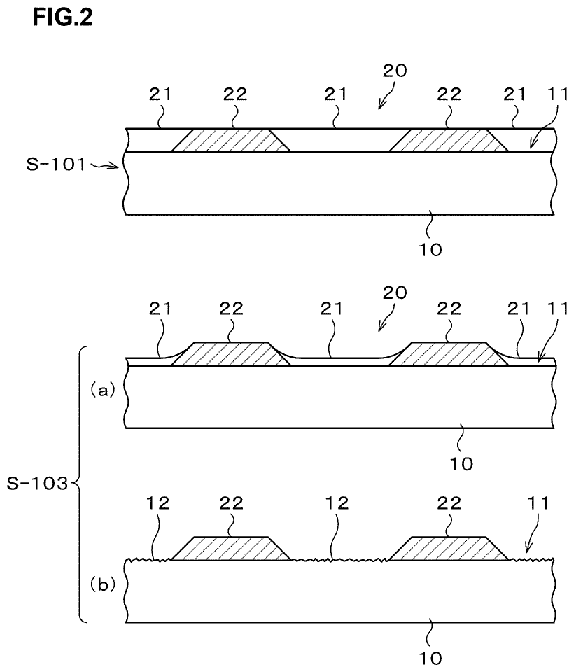

The blast transfer material 20 (wood veneer), which is nonuniform in density and hardness corresponding to the woodgrain pattern, is placed on the surface 11 of the base material 10 in the first process, as illustrated in FIG. 2 (S-101). Then, the blasting process is performed on the surface 11 of the base material 10 through the blast transfer material 20 (S-103) in the second process.

Here, in the second process, the blasting media collides with the blast transfer material 20, and the blast transfer material 20 is ground (S-103). At this time, since the blast transfer material 20 made of the wood veneer has the early material portion 21, which is relatively low in density and hardness, and the late material portion 22, which is relatively high in density and hardness, the early material portion 21, which is relatively low in density and hardness is more ground in the blasting process. On the other hand, the late material portion 22, which is relatively high in density and hardness is less ground in the blasting process (S-103(a)).

Subsequently, in the second process, as the blasting process proceeds, the early material portion 21, which is relatively low in density and hardness, is preferentially ground, and the surface 11 of the base material 10 is partially exposed (S-103). Thus, in the portion of the blast transfer material 20 made of the wood veneer where the early material portion 21 was present, the blasting media collides with the surface 11 of the base material 10, and the partial blasting process is performed (S-103(b)).

On the other hand, the late material portion 22, which is relatively high in density and hardness, is not completely ground, and the late material portion 22 remains partially on the surface 11 of the base material 10. Thus, in the portion of the blast transfer material 20 made of the wood veneer where the late material portion 22 is present, the blasting media does not collide with the surface 11 of the base material 10 and the blasting process is not performed.

Thus, on the surface 11 of the base material 10, the portion of the blast transfer material 20 made of the wood veneer corresponding to the early material portion 21 is processed by blasting, and unevenness (rough surface) 12 following projection conditions is formed at the portion corresponding to the early material portion 21. On the other hand, on the surface 11 of the base material 10, the portion of the blast transfer material 20 made of the wood veneer corresponding to the late material portion 22 is not processed by blasting, and no unevenness (rough surface) is formed at the portion corresponding to the late material portion 22. Thus, according to the nonuniformity of the blast transfer material 20, the unevenness (rough surface) 12 is partially formed on the surface 11 of the base material 10, resulting in that a pattern (unevenness (rough surface) 12) is formed on the surface 11 of the base material 10 according to the grain possessed by the wood veneer used as the blast transfer material 20.

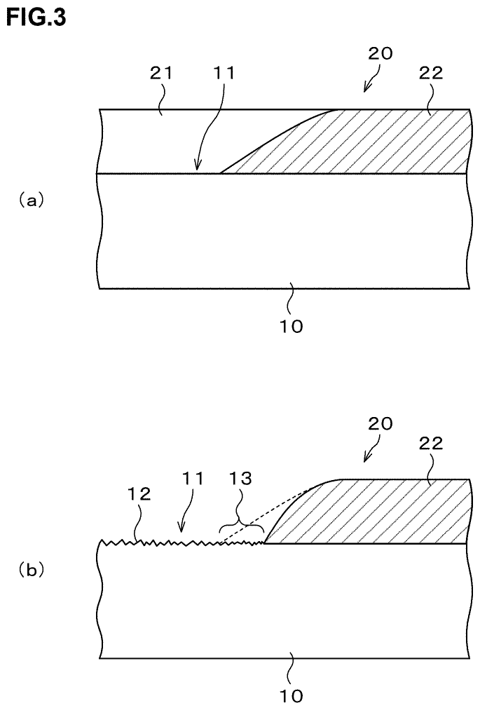

In the blast transfer material 20 made of the wood veneer, a part of the late material portion 22, which is relatively high in density and hardness, may sometimes be ground in a vicinity of a boundary between the early material portion 21 and the late material portion 22. That is, in the blast transfer material 20 made of the wood veneer, the boundary between the early material portion 21 and the late material portion 22 is not necessarily perpendicular to the surface 11 of the base material 10, and for example, the late material portion 22 may diagonally enter below the early material portion 21, as illustrated in FIG. 3(a).

In the case where the late material portion 22 diagonally enters below the early material portion 21, the blasting process has thinned a tip side of the late material portion 22 (the left side in FIG. 3), resulting in that a part of the tip side is ground, and as illustrated in FIG. 3(b), a portion 13 covered by the late material portion 22 (a part of the surface 11 of the base material 10) is exposed. Then, after the exposure, the blasting media collides with the portion 13 that was covered by the late material portion 22, and the blasting process is performed.

On the other hand, in the portion 13 covered by the late material portion 22, compared to the portion covered by the early material portion 21 alone, it takes longer for the surface 11 of the base material 10 to be exposed, resulting in that the time for the blasting process to be performed is also short. As a result, the portion 13 that was covered by the late material portion 22 was originally covered by the early material portion 21 alone and will form a smaller unevenness than the portion where the unevenness (rough surface) 12 was formed by the blasting process.

When the boundary between the early material portion 21 and the late material portion 22 is inclined to the surface 11 of the base material 10, the portion 13 covered by the late material portion 22 will appear as a slight uneven pattern at a periphery of the unevenness (rough surface) 12. This results in the formation of the pattern derived from the blast transfer material 20 on the surface 11 of the base material 10, with natural blurred regions without clear boundaries.

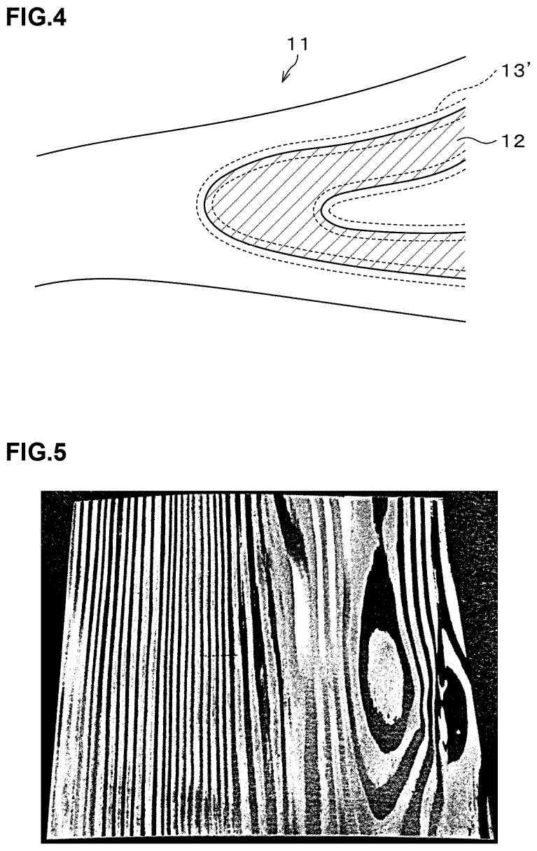

FIG. 4 is an explanatory schematic diagram illustrating a blurred region without a boundary. As illustrated in FIG. 4, on the surface 11 of the base material 10, a slight uneven pattern (which is a region corresponding to the portion 13 covered by the late material portion 22) 13′, which has a lesser degree of unevenness than the unevenness (rough surface) 12, appears at a periphery of the unevenness (rough surface) 12. Thus, the pattern derived from the blast transfer material 20 is formed on the surface 11 of the base material 10 with a natural blurred region without a clear boundary.

4. Post-Processing Process

Post-processing is performed on the base material 10 after blasting according to need, to obtain the material 1 having the surface 11 on which the pattern derived from the blast transfer material 20 is formed (FIG. 1 S-105). The post-processing includes, for example, a cleaning treatment, an anodic oxidation treatment, painting, and the like. In the cleaning treatment, the remaining blast transfer material 20 can be removed together with the water-soluble adhesive by using, for example, water at 5 to 100° C. When the adhesive is not water-soluble, a solvent capable of swelling and dissolving the adhesive may be selected as appropriate.

This process may be omitted.

The material 1 manufactured by the manufacturing method of the material in this embodiment has the pattern derived from the blast transfer material 20 formed on the surface 11. The pattern formed on the surface 11 has natural blurred regions without clear boundaries with shading at each portion, as the pattern is formed through the first and second processes described above. While such naturally blurred regions without clear boundaries exist in natural materials and the like, it has been difficult to form them with conventionally known methods. In contrast, in the manufacturing method of the material in this embodiment, it is possible to manufacture the material 1, which is excellent in design and fully reflects the pattern derived from the raw material.

In other words, the material 1 manufactured by the manufacturing method of the material in this embodiment is a design material deliberately applied with patterns and textures formed by points, lines, unevennesses, and combinations thereof, derived from the blast transfer material 20, for decorative and other purposes.

In the manufacturing method of the material in this embodiment, the pattern and texture of the material 1 can be selected by selecting the type of the blast transfer material 20. In other words, the manufacturing method of the material in this embodiment has excellent versatility in forming patterns derived from a variety of raw materials.

Furthermore, the manufacturing method of the material in this embodiment can manufacture the material 1 with a relatively small number of man-hours through the first and second processes. Besides, the first and second processes described above can be applied to the base material 10 having a relatively large area. Therefore, the manufacturing method of the material in this embodiment is also excellent in terms of productivity. In particular, when a coil is used as the base material 10, that is, when the base material 10 in a strip form is used, the first process and the second process can be performed continuously, which further improves the productivity.

The material 1 obtained in the above manner can be used as: for example, finishing materials for construction such as interior and exterior; materials (interior and exterior) for transport equipment such as vehicles (especially automobiles and railroad cars), ships, aircraft; containers (e.g., tableware); custom-made furniture and residential furniture (e.g., chests, shelves, chairs, desks, bedding); consumer electronics casings; information equipment (IT equipment) casings; residential equipment; clocks; ornaments; signboards; nameplates; sign markers; and stationery. Thus, the material 1 can be a material for the consumer electronics casing, a material for the information equipment casing, a material for the residential equipment, a material for the clock, a material for the ornament, a material for the signboard, a material for the nameplate, a material for the sign marker, a material for the stationery, a material for the container, a material for the residential furniture, a material for the custom-made furniture, a finishing material for construction, or a material for the transport equipment. In particular, the manufacturing method of the material in this embodiment allows for efficient production of the material 1 having a relatively large area, and can therefore be suitable for use as the finishing material for construction and the material for the transport equipment.

Although suitable embodiments of the present invention have been described above, the present invention is not limited to the above-mentioned embodiments. For example, in the above-described embodiment, it is explained that the first and second processes are performed on only one side of the base material 10, but the present invention is not limited thereto, and the first and second processes may be performed on both sides of the base material. In this case, each process may be performed on each side or may be performed in parallel on both sides.

For the blast transfer material, a member in a sheet form whose physical properties such as density, thickness, and hardness are nonuniform in the surface direction due to its structure can be used. For example, on the surface 11 of the base material 10, the wood veneer and the fiber sheet may be placed at different locations, or the wood veneer and the fiber sheet may be placed at the same location, overlapping each other. Examples of the blast transfer material may include vinyl, tablecloth, and so on with an uneven lace pattern or other resins that have nonuniform physical properties such as density, thickness, and hardness.

In the present invention, the “blast transfer material” is a means (member) that does not completely interfere with the blasting process on the surface 11 of the base material 10, but is a means (member) that adjusts the blasting process of each region on the surface 11 of the base material 10 in a nonuniform manner so that some regions on the surface 11 of the base material 10 are blasted and some other regions are not blasted.

Further, for example, when the base material is the metal material such as the titanium material, the stainless-steel material, and the aluminum material, the base material may be colored by the anodic oxidation treatment or the like before and after the first and second processes. This makes it possible to manufacture a material that has a different texture from the material that has gone through the first and second processes only.

### EXAMPLES

Embodiments of the present invention will be concretely described below, showing examples. The following examples are only one example of the present invention, and the present invention is not limited to the following examples.

1. Manufacture of Materials 1.1. Base Material Preparation Process

First, a base material in a sheet form listed in Table 1 was prepared for each example. When the base material was titanium, annealing was performed under a condition illustrated in Table 1, and pickling was performed according to need. In Table 1, pure titanium class 1 based on JIS H 4600 was referred to as “Ti-1” and pure titanium class 2 was referred to as “Ti-2”. In the table, “SUS” is a stainless steel sheet (SUS304), “Al” is an aluminum sheet (A3105P), “glass” is a glass sheet (soda-lime glass), “resin sheet” is a plastic sheet made of acrylic resin, “cloth” is cotton cloth, “ceramic” is cement, “stone” is marble, “graphite” is artificial graphite, and “concrete” is concrete, respectively.

In the table, it was denoted whether vacuum or atmospheric annealing was performed for the annealing. The vacuum annealing was performed with a vacuum degree of 1.0×10⁻³ Torr or less, a temperature of 650° C., and a treatment time of 12 hours. The atmospheric annealing was performed at a temperature of 730° C. or more, and a treatment time of 2 minutes. The pickling was performed by using a nitric acid solution with a hydrofluoric acid concentration of 50 g/L and a nitric acid concentration of 10 g/L to treat the base material for 30 seconds at a treatment temperature of 50° C.

1.2. First Process

Next, for each example, a blast transfer material listed in Table 1 was attached to the surface of the prepared base material. In the table, “wood veneer” is a wood veneer made from natural wood (cedar), “Japanese paper” is traditional Japanese paper (washi) made from camellia, and “shoji paper” is handmade traditional Japanese paper (washi) made from paper mulberry. The term “wallpaper” is wallpaper base-sheet made of paper, “leather material” is artificial leather, and “wood” is an oak sheet material. The blast transfer material was attached to the base material using a water-soluble glue. One or more of the density, thickness, and hardness of the “wood veneer,” “Japanese paper,” “shoji paper,” and “cloth” used as the blast transfer materials in Examples 1-37 are nonuniform.

Furthermore, in Comparative Example 1, a blast transfer material using aluminum foil with printed patterns was formed on the base material. In Comparison Example 2, a blast transfer material using a silicone resin sheet with a printed pattern was formed on the base material. In Comparative Examples 1, 2, these aluminum foil and silicon resin each with the printed pattern have uniform physical properties such as density, thickness, and hardness.

1.3 Second Process

Next, the blasting process was performed to the base material on which the blast transfer material was attached, under the conditions listed in Table 1 from above the blast transfer material.

1.4 Post-Processing Process After blasting, the base material according to each example was washed with water at 50° C. and the remaining blast transfer material was removed together with the water-soluble adhesive to obtain the material in each example.

2. Evaluation

For the material in each example, a similarity between a pattern of the blast transfer material photographed beforehand and a pattern formed on the surface of the base material was visually observed, and the material was rated as “A” when they were extremely similar, “B” when they were very similar, “C” when they were similar to some extent, and “D” when they were seldom similar.

The ratings obtained are listed together in Table 1.

TABLE 1

| | BASE MATERIAL PREPARATION PROCESS | | | FIRST PROCESS | |
|---|---|---|---|---|---|
| | TYPE OF | | | BLAST TRANSFER MATERIAL | |
| | BASE | | | | THICKNESS |
| | MATERIAL | ANNEALING | PICKLING | TYPE | (mm) |
| EXAMPLE 1 | Ti-1 | VACUUM | NOT | WOOD VENEER | 0.32 |
| | | ANNEALING | PERFORMED | | |
| EXAMPLE 2 | Ti-1 | VACUUM | NOT | WOOD VENEER | 0.24 |
| | | ANNEALING | PERFORMED | | |
| EXAMPLE 3 | Ti-1 | VACUUM | NOT | WOOD VENEER | 0.40 |
| | | ANNEALING | PERFORMED | | |
| EXAMPLE 4 | Ti-1 | VACUUM | NOT | WOOD VENEER | 0.57 |
| | | ANNEALING | PERFORMED | | |
| EXAMPLE 5 | Ti-1 | VACUUM | NOT | WOOD VENEER | 0.81 |
| | | ANNEALING | PERFORMED | | |
| EXAMPLE 6 | Ti-1 | VACUUM | NOT | WOOD VENEER | 0.97 |
| | | ANNEALING | PERFORMED | | |
| EXAMPLE 7 | Ti-1 | VACUUM | NOT | WOOD VENEER | 0.29 |
| | | ANNEALING | PERFORMED | | |
| EXAMPLE 8 | Ti-1 | VACUUM | NOT | WOOD VENEER | 0.50 |
| | | ANNEALING | PERFORMED | | |
| EXAMPLE 9 | Ti-1 | VACUUM | NOT | WOOD VENEER | 0.22 |
| | | ANNEALING | PERFORMED | | |
| EXAMPLE 10 | Ti-1 | VACUUM | NOT | JAPANESE | 0.34 |
| | | ANNEALING | PERFORMED | PAPER | |
| EXAMPLE 11 | Ti-1 | VACUUM | NOT | JAPANESE | 0.23 |
| | | ANNEALING | PERFORMED | PAPER | |
| EXAMPLE 12 | Ti-1 | VACUUM | NOT | SHOJI PAPER | 0.22 |
| | | ANNEALING | PERFORMED | | |
| EXAMPLE 13 | Ti-1 | VACUUM | NOT | SHOJI PAPER | 0.75 |
| | | ANNEALING | PERFORMED | | |
| EXAMPLE 14 | Ti-1 | VACUUM | NOT | CLOTH | 0.63 |
| | | ANNEALING | PERFORMED | | |
| EXAMPLE 15 | Ti-1 | VACUUM | NOT | WOOD VENEER | 1.08 |
| | | ANNEALING | PERFORMED | | |
| EXAMPLE 16 | Ti-1 | VACUUM | NOT | WOOD VENEER | 1.01 |
| | | ANNEALING | PERFORMED | | |
| EXAMPLE 17 | Ti-1 | VACUUM | NOT | WOOD VENEER | 0.09 |
| | | ANNEALING | PERFORMED | | |
| EXAMPLE 18 | Ti-1 | VACUUM | NOT | WOOD VENEER | 0.05 |
| | | ANNEALING | PERFORMED | | |
| EXAMPLE 19 | Ti-1 | VACUUM | NOT | WOOD VENEER | 0.24 |
| | | ANNEALING | PERFORMED | | |
| EXAMPLE 20 | Ti-1 | VACUUM | NOT | WOOD VENEER | 0.43 |
| | | ANNEALING | PERFORMED | | |
| EXAMPLE 21 | Ti-1 | VACUUM | NOT | WOOD VENEER | 0.51 |
| | | ANNEALING | PERFORMED | | |
| EXAMPLE 22 | Ti-1 | ATMOSPHERIC | PERFORMED | WOOD VENEER | 0.70 |
| | | ANNEALING | | | |
| EXAMPLE 23 | Ti-1 | ATMOSPHERIC | NOT | WOOD VENEER | 0.82 |
| | | ANNEALING | PERFORMED | | |
| EXAMPLE 24 | Ti-2 | VACUUM | NOT | WOOD VENEER | 0.24 |
| | | ANNEALING | PERFORMED | | |
| EXAMPLE 25 | SUS | — | — | WOOD VENEER | 0.42 |
| EXAMPLE 26 | Al | — | — | WOOD VENEER | 0.52 |
| EXAMPLE 27 | GLASS | — | — | WOOD VENEER | 0.77 |
| EXAMPLE 28 | RESIN SHEET | — | — | WOOD VENEER | 0.29 |
| EXAMPLE 29 | WALLPAPER | — | — | WOOD VENEER | 0.44 |
| EXAMPLE 30 | LEATHER | — | — | WOOD VENEER | 0.23 |
| | MATERIAL | | | | |
| EXAMPLE 31 | WOOD | — | — | JAPANESE | 0.33 |
| | | | | PAPER | |
| EXAMPLE 32 | DENIM | — | — | WOOD VENEER | 0.28 |
| EXAMPLE 33 | CLOTH | — | — | WOOD VENEER | 0.34 |
| EXAMPLE 34 | CERAMIC | — | — | WOOD VENEER | 0.35 |
| EXAMPLE 35 | CONCRETE | — | — | WOOD VENEER | 0.42 |
| EXAMPLE 36 | STONE | — | — | WOOD VENEER | 0.45 |
| EXAMPLE 37 | GRAPHITE | — | — | WOOD VENEER | 0.47 |
| COMPARATIVE | Ti-1 | VACUUM | NOT | ALUMINUM FOIL | 0.26 |
| EXAMPLE 1 | | ANNEALING | PERFORMED | | |
| COMPARATIVE | Ti-1 | VACUUM | NOT | RESIN SHEET | 0.22 |
| EXAMPLE 2 | | ANNEALING | PERFORMED | | |

| | SECOND PROCESS | | | | |
|---|---|---|---|---|---|
| | BLASTING MEDIA | | | | |
| | | | AVERAGE | BLASTING | |
| | | | PARTICLE | PRESSURE | |
| | TYPE | SHAPE | SIZE (μm) | (MPa) | EVALUATION |
| EXAMPLE 1 | ALUMINA | GRID | 100 | 0.43 | A |
| EXAMPLE 2 | ALUMINA | GRID | 1100 | 0.31 | C |
| EXAMPLE 3 | ALUMINA | GRID | 1000 | 0.52 | B |
| EXAMPLE 4 | ALUMINA | GRID | 50 | 0.58 | B |
| EXAMPLE 5 | ALUMINA | GRID | 40 | 0.55 | C |
| EXAMPLE 6 | ALUMINA | GRID | 100 | 0.91 | C |
| EXAMPLE 7 | ALUMINA | GRID | 200 | 0.75 | B |
| EXAMPLE 8 | ALUMINA | GRID | 500 | 0.21 | B |
| EXAMPLE 9 | ALUMINA | GRID | 700 | 0.12 | C |
| EXAMPLE 10 | ALUMINA | GRID | 500 | 0.33 | A |
| EXAMPLE 11 | ALUMINA | GRID | 400 | 0.43 | A |
| EXAMPLE 12 | ALUMINA | GRID | 500 | 0.52 | A |
| EXAMPLE 13 | ALUMINA | GRID | 400 | 0.56 | B |
| EXAMPLE 14 | ALUMINA | GRID | 300 | 0.65 | B |
| EXAMPLE 15 | ALUMINA | GRID | 100 | 0.74 | C |
| EXAMPLE 16 | ALUMINA | GRID | 60 | 0.27 | C |
| EXAMPLE 17 | ALUMINA | GRID | 80 | 0.23 | C |
| EXAMPLE 18 | ALUMINA | GRID | 100 | 0.44 | C |
| EXAMPLE 19 | ZIRCONIA | BEAD | 200 | 0.31 | A |
| EXAMPLE 20 | SiC | GRID | 300 | 0.54 | A |
| EXAMPLE 21 | GLASS | BEAD | 400 | 0.78 | B |
| EXAMPLE 22 | ALUMINA | GRID | 500 | 0.60 | B |
| EXAMPLE 23 | ALUMINA | GRID | 200 | 0.69 | C |
| EXAMPLE 24 | ALUMINA | GRID | 300 | 0.53 | A |
| EXAMPLE 25 | ALUMINA | GRID | 200 | 0.40 | A |
| EXAMPLE 26 | ALUMINA | GRID | 100 | 0.32 | A |
| EXAMPLE 27 | ALUMINA | GRID | 800 | 0.21 | C |
| EXAMPLE 28 | ALUMINA | GRID | 50 | 0.37 | B |
| EXAMPLE 29 | ALUMINA | GRID | 200 | 0.41 | A |
| EXAMPLE 30 | ALUMINA | GRID | 300 | 0.47 | A |
| EXAMPLE 31 | ALUMINA | GRID | 300 | 0.51 | A |
| EXAMPLE 32 | ALUMINA | GRID | 200 | 0.39 | A |
| EXAMPLE 33 | ALUMINA | GRID | 200 | 0.33 | A |
| EXAMPLE 34 | ALUMINA | GRID | 200 | 0.43 | A |
| EXAMPLE 35 | ALUMINA | GRID | 100 | 0.45 | A |
| EXAMPLE 36 | ALUMINA | GRID | 150 | 0.52 | A |
| EXAMPLE 37 | ALUMINA | GRID | 200 | 0.41 | A |
| COMPARATIVE | ALUMINA | GRID | 200 | 0.41 | D |
| EXAMPLE 1 | | | | | |
| COMPARATIVE | ALUMINA | GRID | 100 | 0.32 | D |
| EXAMPLE 2 | | | | | |

As listed in Table 1, the materials according to this embodiment shown in Examples 1-32 were rated as any of “C” to be similar to some extent, “B” to be very similar, and “A” to be extremely similar. On the other hand, as listed in Table 1, the materials shown in Comparative Examples 1 to 2 were rated as “D” to be seldom similar. The above examples have shown that it is possible to form natural blurred regions without clear boundaries and to express patterns derived from the raw material by using the manufacturing method of the material in this embodiment. A photograph of the material in Example 1 is illustrated in FIG. 5.

Preferred embodiments of the present invention have been described above in detail, but the present invention is not limited to these examples. It should be understood that various changes and modifications are readily apparent to those skilled in the art to which the present invention belongs within the scope of the technical idea as set forth in claims, and those should also be covered by the technical scope of the present invention.

### EXPLANATION OF CODES

1 . . . material

10 . . . base material

20 . . . blast transfer material

100 . . . air nozzle

1. A manufacturing method of a material, comprising:
placing a blast transfer material on a surface of a base material, and
blasting to the surface of the base material through the blast transfer material, wherein
the blast transfer material is nonuniform in one or more of density, thickness, and hardness.

2. The manufacturing method of the material according to claim 1, further comprising:
removing the blast transfer material after the blasting.

3. The manufacturing method of the material according to claim 1, wherein
the blast transfer material is one or both of a wood veneer and a fiber sheet.

4. The manufacturing method of the material according to claim 3, wherein
the fiber sheet is a cloth or a traditional Japanese paper.

5. The manufacturing method of the material according to claim 1, wherein
the base material is a glass material, a ceramic material, a resin material, concrete, stone, graphite, cloth, a paper material, wood, a woody material, a leather material, or a metal material.

6. The manufacturing method of the material according to claim 5, wherein
the base material is the metal material of any of a titanium material, a stainless-steel material, and an aluminum material.

7. The manufacturing method of the material according to claim 6, wherein
in the blasting, blasting media with an average particle size of 50 μm or more and 1000 μm or less is used.

8. The manufacturing method of the material according to claim 6, wherein
a blasting pressure in the blasting is 0.20 MPa or more and 0.80 MPa or less.

9. The manufacturing method of the material according to claim 8, wherein
a thickness of the blast transfer material is 0.10 mm or more and 1.00 mm or less.

10. The manufacturing method of the material according to claim 6, wherein
the base material is the titanium material, and
vacuum annealing or pickling the titanium material before the placing is included.

11. The manufacturing method of the material according to claim 1, wherein
the material is a material for consumer electronics casings, a material for information equipment casings, a material for residential equipment, a material for clocks, a material for ornaments, a material for signboards, a material for nameplates, a material for sign markers, a material for stationery, a material for vessels, a material for residential furniture, a material for custom-made furniture, a finishing material for construction, or a material for transport equipment.
